(19) United States
(12) Patent Application Publication
(10) Pub. No.: US 2016/0017530 A1
(43) Pub. Date: Jan. 21, 2016

(54) WASHING MACHINE

(71) Applicant: Samsung Electronics Co., Ltd., Suwon-si (KR)

(72) Inventors: Han Kyu CHOI, Suwon-si (KR); In Hwan KIL, Seoul (KR); Han Earl LEE, Seoul (KR); Ki Tae PARK, Deagu (KR); Jae Won LEE, Seoul (KR)

(73) Assignee: Samsung Electronics Co., Ltd., Suwon-si (KR)

(21) Appl. No.: 14/331,329

(22) Filed: Jul. 15, 2014

(51) Int. Cl. D06F 37/26; D06F 37/28; E05D 7/00; D06F 37/06

(52) U.S. Cl. CPC D06F 37/267; D06F 37/06; D06F 37/28; E05D 7/00

(57) ABSTRACT

A washing machine provided with an improved structure of a front surface frame thereof to which a door is coupled. The washing machine includes a cabinet forming an external appearance of the washing machine, an opening part provided at the cabinet through which laundry is inserted and withdrawn, a door coupled to the cabinet to open/close the opening part, a mounting part provided at a front surface of the cabinet and allowing the door to be mounted thereon, and at least one rib provided at the mounting part and configured to reinforce strength of the cabinet, so that the strength of the frame to which the door is assembled is reinforced to prevent the door from drooping due to weight of the door, and to reduce noise generated due to vibration of the frame when the washing machine operates.

### CROSS-REFERENCE TO RELATED APPLICATIONS

This application claims the benefit of the Korean Patent Application No. 10-2013-0084429, filed on Jul. 17, 2013, in the Korean Intellectual Property Office, the disclosure of which is incorporated herein by reference.

### BACKGROUND

1. Field

Embodiments of the present disclosure relate to a washing machine, and more particularly, to a washing machine provided with an improved structure of a front surface frame to which a door is coupled.

2. Description of the Related Art

A washing machine is an apparatus configured to wash laundry by use of a power, and in general, is divided into a pulsator type and a drum type according to a washing method. In a case of the drum type, the washing machine is provided with a tub to store washing water, a drum rotatably installed at an inside the tub, and a driving motor configured to rotate the drum. In a state where laundry and washing water are input into the drum, as the drum is rotated, stains on the laundry are removed as the laundry makes friction with the drum and the washing water.

In general, the drum-type washing machine includes a cabinet forming a space to accommodate a drum and a driving motor at an inside thereof, and an upper cover to cover an open upper portion of the cabinet.

A door is coupled to a front surface frame positioned at a front surface of the cabinet. A user may be able to insert laundry into or withdraw laundry from an inside the drum by opening/closing the door.

Conventionally, in a case when the thickness of the front surface frame is thin, as the drum-type washing machine is being used for a long period of time, the door coupled to the front surface frame droops, and as a result, the strength of the door is weakened. In addition, by the vibration generated at the time of when the drum-type washing machine operates, noise is generated, and to prevent the noise as such from being generated, a sound absorbing member is used. However, in this case, a structure or a fastening member is required to mount the sound absorbing member on the drum-type washing machine, and thus the production efficiency is reduced. In addition, in a case when using rubber as the sound absorbing member, the noise is not effectively reduced due to the heat generated by the driving of the drum-type washing machine.

### SUMMARY

Therefore, it is an aspect of the present disclosure to provide a washing machine capable of using a frame having a thinner thickness thereof by reinforcing the strength of the frame to which a door is coupled.

Additional aspects of the disclosure will be set forth in part in the description which follows and, in part, will be apparent from the description, or may be learned by practice of the disclosure.

In accordance with one aspect of the present disclosure, a washing machine includes a cabinet, an opening part, a door, and at least one rib. The cabinet may form an external appearance of the washing machine. The opening part may be provided at the cabinet through which an insertion and a withdrawal of laundry may take place. The door may be coupled to the cabinet to open/close the opening part. The mounting part may be provided at a front surface of the cabinet and allow the door to be mounted thereon. The at least one rib may be provided at the mounting part and configured to reinforce strength of the cabinet.

The at least one rib may include a first rib formed around the opening part.

The opening part may have the shape of a ring, and the first rib may be provided at a circumference of the opening part.

The first rib may include an inner side first rib and an outer side first rib spaced apart by a predetermined distance.

The first rib may be provided in a concave manner with respect to an outer surface of the mounting part.

The rib may be provided in at least one step with respect to the outer surface of the mounting part.

The at least one rib may include a second rib provided in a way to be radially extended from the opening part.

The number of second ribs may be 6 or more and 10 or less.

The second rib may be concaved to have a depth of 3 mm or larger and 6 mm or smaller with respect to an outer surface of the mounting part.

The washing machine may further include a hinge apparatus provided at the mounting part and configured to couple the door to the cabinet.

The washing machine may further include a door switch provided at one surface of the door to lock the door; and a door locking apparatus provided at one surface of the cabinet and coupled to the door switch.

In accordance with another aspect of the present disclosure, a washing machine includes a cabinet, a door, a hinge apparatus, a mounting part, a coupling part and a first rib. The cabinet may have a plurality of frames. The door may be coupled to a first frame among the plurality of frames. The hinge apparatus may allow the first frame and the door to be coupled to each other so that the door is rotatable with respect to the first frame. The mounting part may be provided at the first frame and to which the door may be coupled. The coupling part may be provided at the first frame and to which the hinge apparatus may be coupled. The first rib may be provided at the mounting part and the coupling part to reinforce strength of the first frame.

The first rib may be formed around the mounting part.

The washing machine may further include a second rib that may be radially provided at the mounting part in a direction different from a direction of the first rib to reinforce strength of the mounting part.

The first rib and the second rib may be provided in a concave manner with respect to the mounting part, and depths of the first rib and the second rib may be identical.

The first rib and the second rib may be provided in a concave manner with respect to the mounting part, and depths of the first rib and the second rib may be not identical.

The first rib may include an inner side first rib provided at an inner side of the mounting part; and an outer side first rib provided at an outer side of the mounting part.

The mounting part may be provided in a concave manner with respect to the first frame.

The first rib may include a first step portion provided in a concave manner with respect to the mounting part and a second step portion provided in a concave manner with respect to the first step portion.

The first frame may be provided at a front surface of the cabinet.

In accordance with another aspect of the present disclosure, a washing machine includes a cabinet, an opening part, a door, a hinge apparatus, a coupling part, and at least one rib. The cabinet may have a first frame disposed at a front surface of the washing machine. The opening part may be provided at the first frame and through which an insertion and a withdrawal of laundry may take place. The door may be coupled to the first frame to open/close the opening part. The hinge apparatus may be configured to couple the door to the first frame. The coupling part may be positioned at the first frame and to which the hinge apparatus may be coupled. The at least one rib may be provided at the coupling part to reinforce strength of the coupling part.

The at least one rib may be provided to surround at least a portion of a circumference of the opening part.

A washing machine in accordance with one aspect of the present disclosure is capable of preventing a recession of a door by the weight of the door, by reinforcing the strength of a frame to which the door is assembled.

In addition, the frame to which the door is assembled to is capable of reducing a noise generated at the time of when the washing machine is driven and vibrated.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating an external appearance of a washing machine in accordance with one embodiment of the present disclosure.

FIG. 2 is a drawing illustrating a first frame of the washing machine in accordance with one embodiment of the present disclosure.

FIG. 3 is an enlarged view illustrating a portion of the first frame of the washing machine in accordance with one embodiment of the present disclosure.

FIG. 4 is a view illustrating a state of a door disassembled from the washing machine in accordance with one embodiment of the present disclosure.

FIG. 5 is a cross-sectional view taken along line A-A′ of FIG. 2.

FIG. 6 is a drawing illustrating a first frame of a washing machine in accordance with another embodiment of the present disclosure.

FIG. 7 is a cross-sectional view taken along line B-B′ of FIG. 6.

FIG. 8 is a cross sectional view of a first frame of a washing machine in accordance with still another embodiment of the present disclosure.

FIG. 9 is a front side view illustrating a first frame of a washing machine in accordance with still another embodiment of the present disclosure.

FIG. 10 is a rear side view illustrating the first frame of the washing machine in accordance with still another embodiment of the present disclosure.

FIG. 11 is a cross-sectional view taken along line C-C′ of FIG. 9.

### DETAILED DESCRIPTION

Reference will now be made in detail to the embodiments of the present disclosure, examples of which are illustrated in the accompanying drawings, wherein like reference numerals refer to like elements throughout.

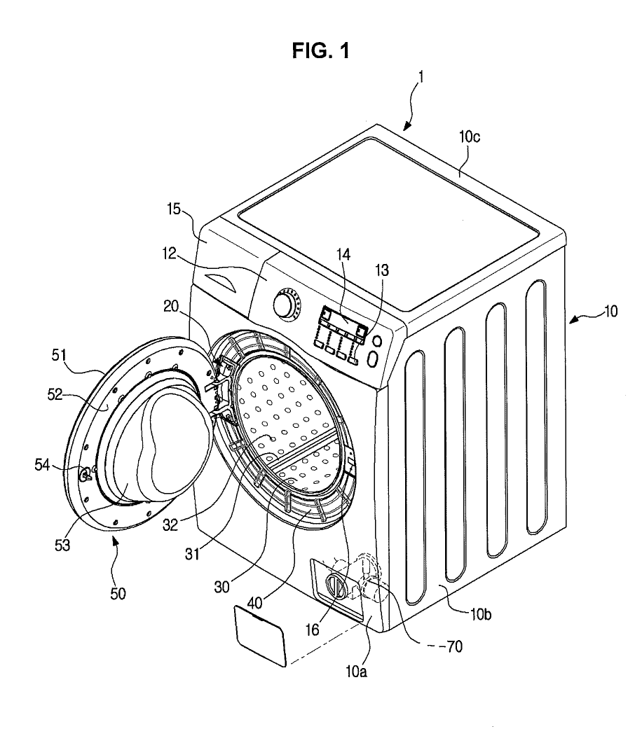

FIG. 1 is a perspective view illustrating an external appearance of a washing machine in accordance with one embodiment of the present disclosure.

As illustrated on FIG. 1, a washing machine 1 in accordance with one aspect of the present disclosure includes a cabinet 10 forming an external appearance, a tub (not shown) installed at an inside the cabinet 10 and in which washing water is stored, and a drum 30 rotatably installed at an inside the tub (not shown) to wash laundry.

A draining pump 70 configured to discharge water of the tub (not shown) to an outside may be positioned at a lower portion of the tub (not shown). The draining pump 70 is provided with one side thereof connected to the tub (not shown) as to discharge the water at an inside the tub (not shown) to an outside, while the other side thereof is connected to a connecting hose (not shown). The draining pump 70 is configured to pump the washing water stored at the tub (not shown), and accordingly, at the time of the driving of the draining pump 70, a vibration is generated, and the vibration is delivered to the cabinet 10.

A control panel assembly 12 is provided at an upper portion of a front surface of the cabinet 10 as to control a motion of the washing machine. Various manipulation buttons 13 and a display unit 14 are provided at the control panel assembly 12. A detergent supplying apparatus 15 is provided at one side of the control panel assembly 12 to supply detergent to an inside the drum 30.

A plurality of through holes 32 are provided at an inside the drum 30, and a lifter 31 configured to ascend and descend laundry is provided at an inner circumferential surface of the drum 30.

An opening part 17 is formed at a front surface of the cabinet 10 to insert laundry into an inside the drum 30, and a door 50 configured to open/close the opening part 17 is installed at the front surface of the cabinet 10.

An upper cover 10c is coupled to an upper portion of the cabinet 10. The cabinet 10 includes a plurality of frames 10a and 10b forming a space to accommodate various components at an inside the cabinet 10. The plurality of frames 10a and 10b include a first frame 10a positioned at a front surface of the cabinet 10, a second frame positioned at a rear surface of the cabinet 10, and third frames 10b positioned at both sides of the cabinet 10.

An insertion groove 16 into which a door locking apparatus 54, which is to be described later, is provided at one side of the opening part 17 of the cabinet 10. At an inside the insertion groove 16, a door switch (not shown) may be embedded. The door switch (not shown) is electrically connected to a control unit (not shown) of the washing machine 1, and is configured to restraint a coupling with respect to the door locking apparatus 54. That is, the door switch (not shown) is coupled to the door locking apparatus 54 or releases the coupling, according to an electrical signal.

The door 50 includes a door cover 51 hinged to the first frame 10a, a door glass 53 coupled to the door cover 51, and a door glass holder 52 configured to couple the door glass 53 to the door cover 51.

The door cover 51 and the door glass holder 52 each is provided with a central portion thereof open in the shape of a ring that allows the door glass 53, which may be transparent, to be coupled thereto. The door cover 51 and the door glass holder 52 are coupled to each other by a plurality of coupling screws (not shown). The door glass 53 has an edge thereof press-fitted into between the door cover 51 and the door glass holder 52, thereby being integrally coupled to the door cover 51 and the door glass holder 52.

The door cover 51 is coupled to a hinge shaft 22 of the hinge apparatus 20 coupled to the first frame 10a and thus pivoted on the hinge shaft 22.

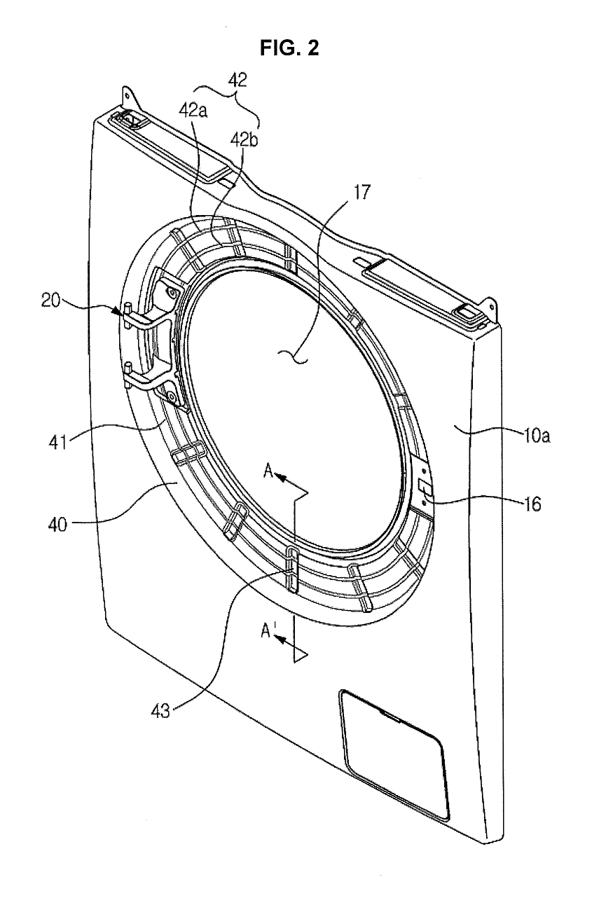

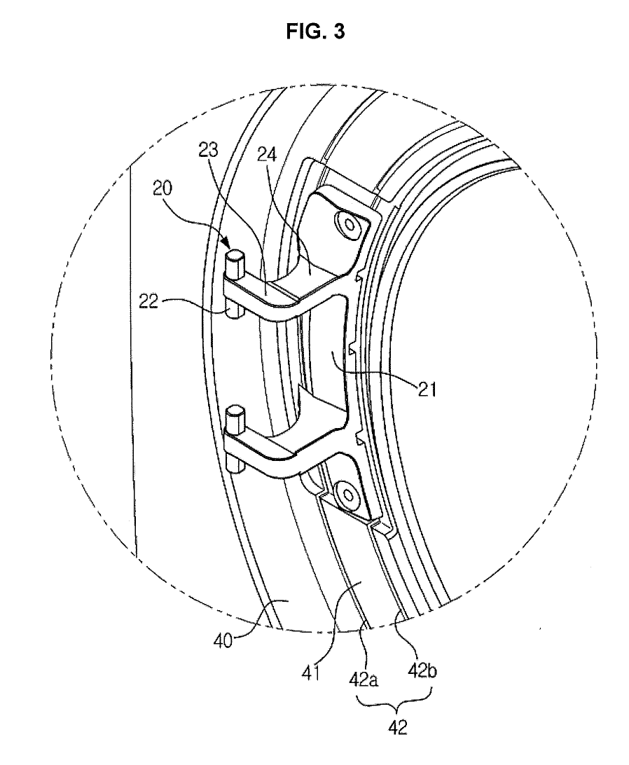

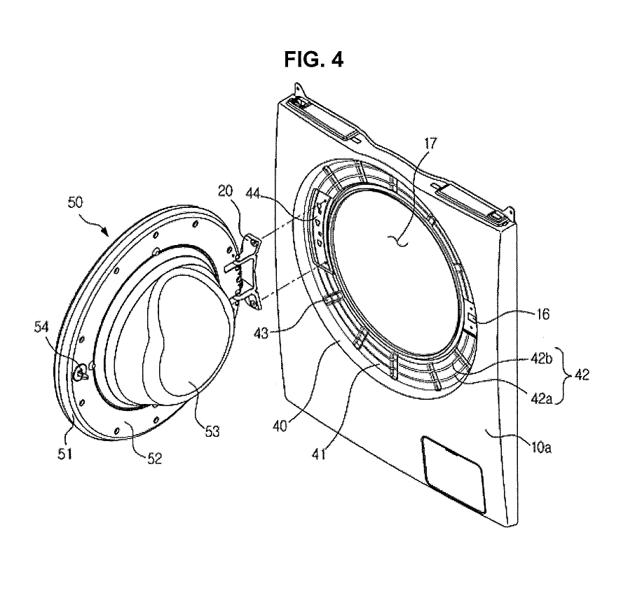

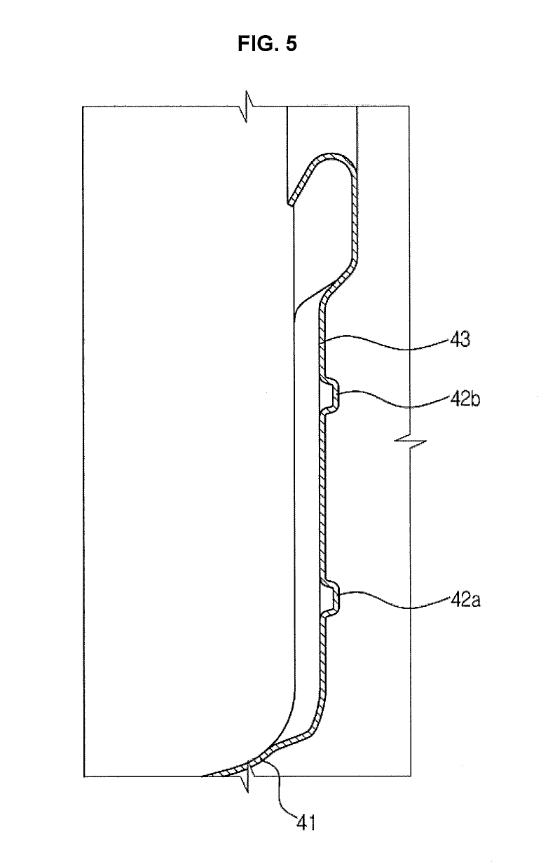

FIG. 2 is a drawing illustrating a first frame of the washing machine in accordance with one embodiment of the present disclosure, FIG. 3 is an enlarged view illustrating a portion of the first frame of the washing machine in accordance with one embodiment of the present disclosure, FIG. 4 is a view illustrating a state of a door disassembled from the washing machine in accordance with one embodiment of the present disclosure, and FIG. 5 is a cross-sectional view taken along line A-A′ of FIG. 2.

As illustrated on FIGS. 2 to 5, a mounting part 40 at which the door 50 is mounted may be provided on at least one portion of the cabinet 10. The mounting part 40 may be positioned at the first frame 10a positioned at a front surface of the cabinet 10. The mounting part 40 may be provided in a concave manner with respect to an outer surface of the first frame 10a, and the manner as such enables an effect that the door 50 is not being protruded with respect to the first frame 10a while the door 50 is accommodated at the mounting part 40 at the time of when the opening part 17 is closed by the door 50.

At least one rib 42 and rib 43 may be provided at the mounting part 40 as to reinforce the strength of the first frame 10a. The at least one rib 42 and 43 includes a first rib 42 formed along the circumference of the opening part 17, and a second rib 43 radially extended from the opening part 17. That is, the first rib 42 and the second rib 43 may be provided in a way to have different directions with respect to each other.

The opening part 17 has the shape of a ring, and the first rib 42 may be provided around the opening part 17. The first rib 42 may be provided in a concave manner with respect to an outer surface 41 of the mounting part 40. The first rib 42 may be provided in a plurality thereof. In accordance with one embodiment of the present disclosure, an inner side first rib 42b, and an outer side first rib 42a farther spaced apart from the opening part 17 that the inner side first rib 42b is provided at the mounting part 40. Although the first rib 42 is illustrated as being provided in the total of two units, the present disclosure is not limited thereto. For example, the first rib 42 may be provided in one unit, or provided in two or more units thereof.

The hinge apparatus 20 allowing the door 50 and the first frame 10a to be coupled to each other is coupled to the mounting part 40. The hinge apparatus 20 may be coupled to a coupling part 44 provided in a concave manner with respect to the mounting part 40.

The hinge apparatus 20 includes a hinge body 21 coupled to an outer portion of the opening part 17 of the first frame 10a, the hinge shaft 22 rotatably supported with respect to the door 50, and a hinge protrusion 24 connecting the hinge body 21 to the hinge shaft 22. The hinge protrusion 24 may include a hinge bent part 23 bentedly extending from the hinge protrusion 24 for a smooth motion of the hinge shaft 22.

More in detail, the first rib 42 may be provided at the coupling part 44 to which the hinge apparatus 20 is coupled. The coupling part 44 may be provided in a concave manner with respect to an outer surface 41 of the mounting part 40. The strength of the coupling part 44 may be reinforced as the first rib 42 is positioned at the coupling part 44.

The second rib 43 is provided in a plurality thereof in a radial manner. The second rib 43 may be provided in a concave manner with respect to the outer surface 41 of the mounting part 40. In accordance with one embodiment of the present disclosure, the second ribs 43 are provided in a total of 6 or more and 10 or less around the opening part 17. According to the illustration of the drawing, a total of 10 second ribs 43 are provided. The number of the second ribs 43 may be variously provided according to the size of the mounting part 40 and the thickness of the first frame 10a, and is not limited hereto. The second rib 43 may have a depth of 3 mm or larger and 6 mm or smaller with respect to an outer surface of the mounting part 40. In addition, the respective second ribs 43 may be provided to be spaced apart from each other. The distance between each second rib 43 may be identical or not identical.

In accordance with one embodiment of the present disclosure, the first rib 42 and the second rib 43 may be provided at the mounting part 40. As shown in the drawings, the depths of the first rib 42 and the second rib 43 are not identical, but are not limited hereto, and the depths of the first rib 42 and the second rib 43 may be identical. In more detail, according to the illustration on the drawing, the depth of the first rib 42 is provided to be deeper than the depth of the second rib 43. Alternatively, the depth of the second rib 43 may be provided to be deeper than the depth of the first rib 42.

The strength of the first frame 10a is much reduced when not reinforced by the first rib 42 and the second rib 43, so that a drooping of the door 50 occurs when the thickness of the first frame 10a is set to 0.6 mm or below. In addition, the vibration of the tub (not shown) at the time of the driving of the washing machine 1 is delivered to the first frame 10a and a noise is generated, and the vibration from the driving of the draining pump 70 at the time of a draining is delivered to the first frame 10a to cause the vibration of the door 50 and thus a noise is generated. In addition, according to the above, in a case when the washing machine 1 is being used for a long period of time, the door droops and thus the strength of the door is weakened. In general, a sound absorbing member may be additionally installed at the first frame 10a so as to prevent the above. In a case when the sound absorbing member is being used, the cost of production is increased, and also, by the high-temperature heat generated from the driving of the washing machine, the sound absorbing member is melted, and thus an effect of the sound absorbing member is not normally expected. However, in accordance with one embodiment of the present disclosure, by the ribs 42 and 43 positioned at the mounting part 40, the vibration generated from the tub (not shown) may be prevented from being delivered to the first frame 10a, and thus the noise generated by the vibration of the first frame 10a may be reduced.

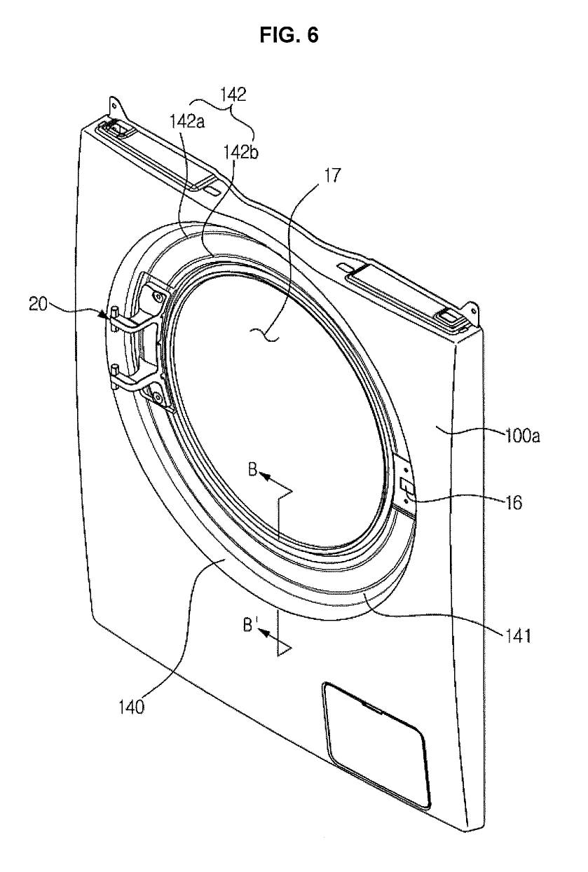

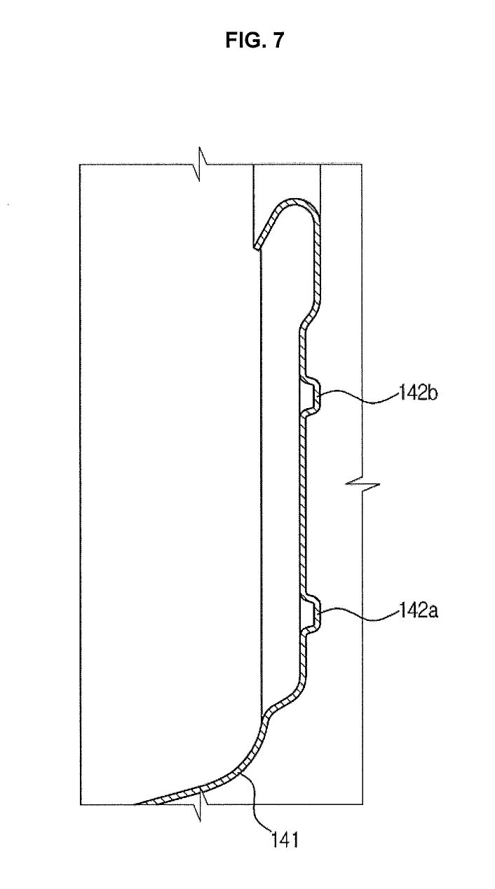

FIG. 6 is a drawing illustrating a first frame of a washing machine in accordance with another embodiment of the present disclosure, and FIG. 7 is a cross-sectional view taken along line B-B′ of FIG. 6. Description of components having the same reference figures as those of FIGS. 1 to FIG. 5 will be omitted.

As illustrated on FIG. 6 and FIG. 7, in accordance with another embodiment of the present disclosure, a first rib 142 only may be provided at a mounting part 140. The first rib 142 may include an inner side first rib 142b and an outer side first rib 142a.

The hinge apparatus 20 configured to couple the door 50 to the cabinet 10 is coupled to the mounting part 140, and the at least one first rib 142 is provided at the mounting part 140, and thus the drooping of the door 50 from a first frame 100a by the weight of the door 50 may be prevented.

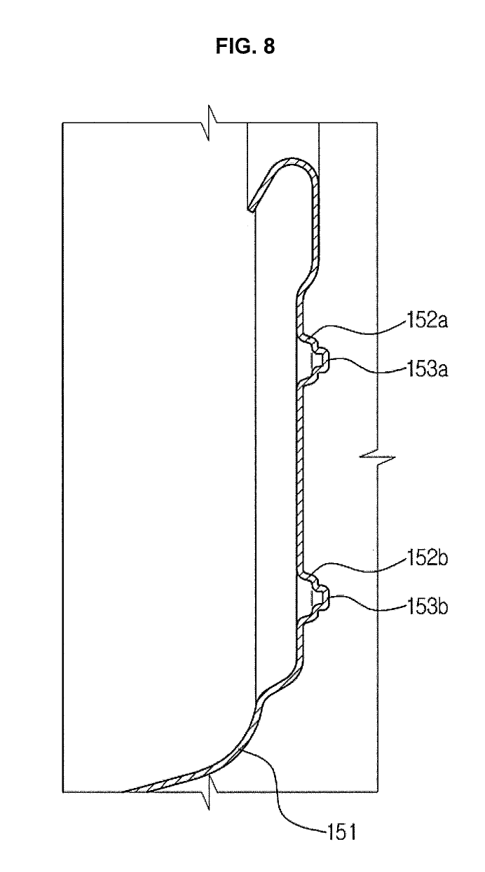

FIG. 8 is a cross sectional view of a first frame of a washing machine in accordance with still another embodiment of the present disclosure.

As illustrated on FIG. 8, a first rib may be provided to be stepped with respect to an outer surface 151 of the mounting part. The first rib may include first step portions 152a and 152b provided in a concave manner with respect to the outer surface 151 of the mounting part, and second step portions 153a and 153b provided in a concave manner with respect to the first step portions 152a and 152b. According to FIG. 8, two units of step portions are provided, but the present disclosure is not limited hereto.

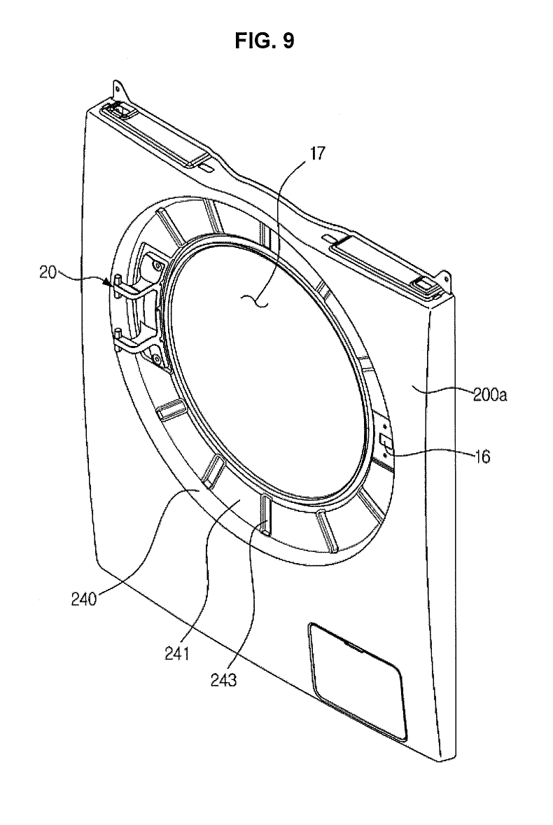

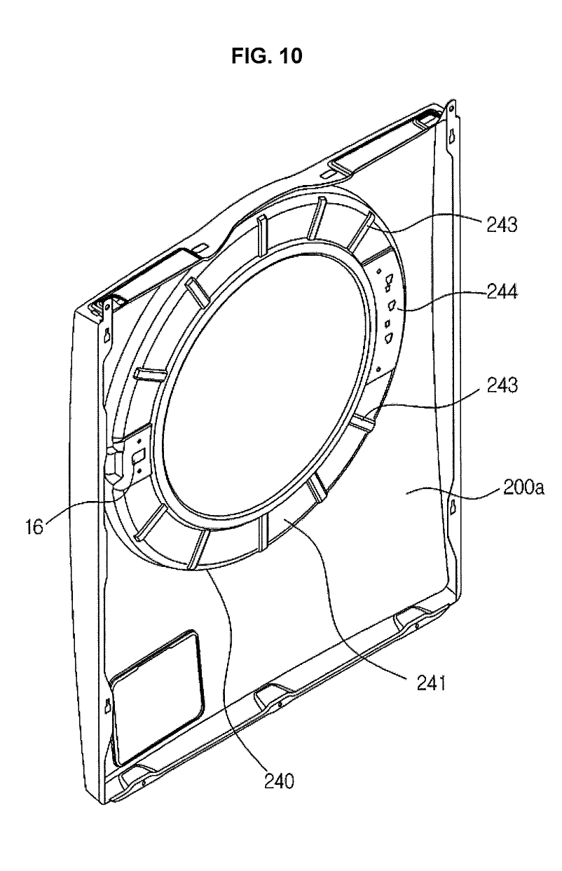

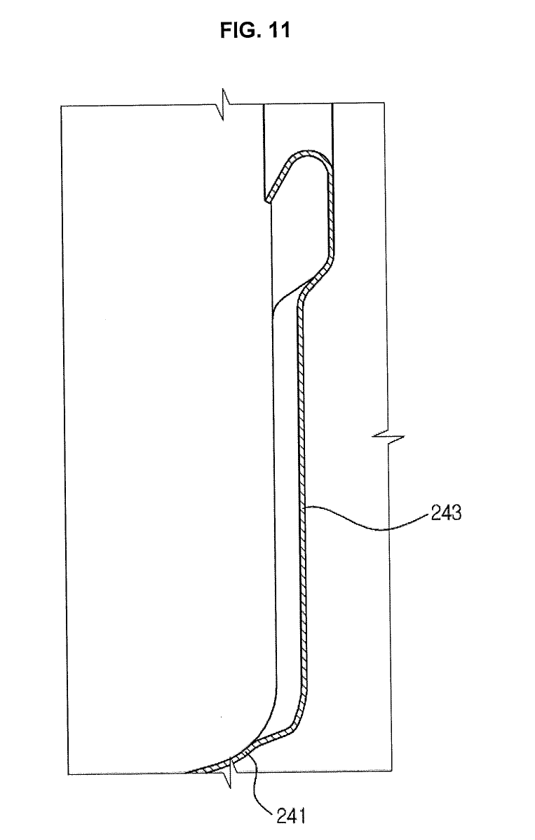

FIG. 9 is a front side view illustrating a first frame of a washing machine in accordance with still another embodiment of the present disclosure, FIG. 10 is a rear side view illustrating the first frame of the washing machine in accordance with still another embodiment of the present disclosure, and FIG. 11 is a cross-sectional view taken along line C-C′ of FIG. 9. Descriptions of the same components as those of the FIGS. 1 to 5 will be omitted.

As illustrated on FIG. 9 to FIG. 11, in accordance with still another embodiment of the present disclosure, a second rib 243 provided in the radial shape may only be provided at a mounting part 240. The second rib 243 may be provided in a plurality thereof, and in a case when the plurality of second ribs 243 are provided, the respective second ribs 243 are provided to be spaced apart from each other. The distance between each second rib 243 may be identical. The number of the second ribs 243 provided at an upper side of the opening part 17 may be the same as that of the second ribs 243 provided at a lower side of the opening part 17. According to the illustration of FIG. 9, at the upper side of the opening part 17, a total of 5 second ribs 243 are positioned, and at the lower side of the opening part 17, a total of 5 second ribs 243 may be positioned. In a case when a total of 6 second ribs is positioned, at each of the upper and the lower sides of the opening part 17, a total of 3 second ribs may be positioned.

The second rib 243 may be provided to be concaved inward the washing machine 1. That is, when a first frame 200a is seen from a rear side, the second rib 243 is protruded toward an outer side of the washing machine 1, and when the first frame 200a is seen from a front side, the second rib 243 is concaved inward the washing machine 1.

In accordance with still another embodiment of the present disclosure, as the second rib 243 is positioned, the strength of the first frame 200a and coupling part 244 is increased, and thus the delivery of a vibration from the tub (not shown) is reduced, and thereby a noise may be decreased.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A washing machine, comprising:
a cabinet forming an external appearance of the washing machine;
an opening part provided at the cabinet to insert and withdraw laundry;
a door coupled to the cabinet to open/close the opening part;
a mounting part provided at a front surface of the cabinet to mount the door thereon; and
at least one rib provided at the mounting part and configured to reinforce strength of the cabinet.

2. The washing machine of claim 1, wherein the at least one rib comprises a first rib formed around the opening part.

3. The washing machine of claim 2, wherein the opening part has the shape of a ring, and the first rib is provided at a circumference of the opening part.

4. The washing machine of claim 2, wherein the first rib comprises an inner side first rib and an outer side first rib, the inner side first rib and the outer side first rib being spaced apart on the opening part by a predetermined distance.

5. The washing machine of claim 2, wherein the first rib is provided in a concave manner with respect to an outer surface of the mounting part.

6. The washing machine of claim 5, wherein the first rib is provided in at least one step with respect to the outer surface of the mounting part.

7. The washing machine of claim 1, wherein the at least one rib comprises a second rib provided to be radially extended from the opening part.

8. The washing machine of claim 7, wherein the second rib comprises 6 or more second ribs and 10 or less second ribs.

9. The washing machine of claim 7, wherein the second rib is concaved to have a depth of 3 mm or larger and 6 mm or smaller with respect to an outer surface of the mounting part.

10. The washing machine of claim 1, further comprising a hinge apparatus provided at the mounting part and configured to couple the door to the cabinet.

11. A washing machine, comprising:
a cabinet having a plurality of frames;
a door coupled to a first frame among the plurality of frames;
a hinge apparatus allowing the first frame and the door to be coupled to each other so that the door is rotatable with respect to the first frame;
a mounting part provided at the first frame and to which the door is coupled;
a coupling part provided at the first frame and to which the hinge apparatus is coupled; and
a first rib provided at the mounting part and the coupling part to reinforce strength of the first frame.

12. The washing machine of claim 11, wherein the first rib is formed around the mounting part.

13. The washing machine of claim 12, further comprising a second rib radially provided at the mounting part in a direction different from a direction of the first rib to reinforce strength of the mounting part.

14. The washing machine of claim 13, wherein the first rib and the second rib are provided in a concave manner with respect to the mounting part, and depths of the first rib and the second rib are identical.

15. The washing machine of claim 13, wherein the first rib and the second rib are provided in a concave manner with respect to the mounting part, and depths of the first rib and the second rib are not identical.

16. The washing machine of claim 11, wherein the first rib comprises:
an inner side first rib provided at an inner side of the mounting part; and
an outer side first rib provided at an outer side of the mounting part.

17. The washing machine of claim 11, wherein the mounting part is provided in a concave manner with respect to the first frame.

18. The washing machine of claim 11, wherein the first rib comprises a first step portion provided in a concave manner with respect to the mounting part and a second step portion provided in a concave manner with respect to the first step portion.

19. The washing machine of claim 11, wherein the first frame is provided at a front surface of the cabinet.

20. A washing machine, comprising:
a cabinet having a first frame disposed at a front surface of the washing machine;
an opening part provided at the first frame through which laundry is inserted and withdrawn;
a door coupled to the first frame to open/close the opening part;
a hinge apparatus configured to couple the door to the first frame;
a coupling part positioned at the first frame and to which the hinge apparatus is coupled; and
at least one rib provided at the coupling part to reinforce strength of the coupling part.

21. The washing machine of claim 20, wherein the at least one rib is provided to surround at least a portion of a circumference of the opening part.
